(19) United States
(12) Patent Application Publication
(10) Pub. No.: US 2004/0165271 A1
(43) Pub. Date: Aug. 26, 2004

(54) Enhancing light coupling efficiency for ultra high numerical aperture lithography through first order transmission optimization

(76) Inventors: Christof Gabriel Krautschik, Cupertino, CA (US); Maciek E. Orczyk, Cupertino, CA (US); John M. Urata, Portland, OR (US)

Correspondence Address: FISH & RICHARDSON, PC, 12390 EL CAMINO REAL, SAN DIEGO, CA, 92130-2081, US

(21) Appl. No.: 10/371,567

(22) Filed: Feb. 21, 2003

(51) Int. Cl. B32B 1/00; G02B 1/10

(52) U.S. Cl. 359/580

(57) ABSTRACT

A first order transmission optimization (FOTO) top coat may be provided on a photoresist layer to improve the coupling efficiency of first order diffracted light waves during a lithographic imaging operation. The top coat may be a relatively thin layer of a relatively low absorption, low refractive index material. The top coat may be provided in addition to a bottom anti-reflective coating (BARC).

### BACKGROUND

The process flow for semiconductor manufacturing may include front-end processing and back-end processing. Front-end processing may include wafer fabrication, and back-end processing may include testing, assembly, and packaging. During wafer fabrication, different layers of material may be formed on the wafer using, e.g., photolithography, etching, stripping, diffusion, ion implantation, deposition, and chemical mechanical planarization processes.

Increasingly higher Numerical Aperture (NA) optics may be used in lithography manufacturing to pattern increasingly smaller features. However, coupling light efficiently into a photoresist may become increasingly difficult in an optical system as the NA increases. As the NA increases, the incidence angle of the first order diffracted light waves may increase, and the resist surface may begin to act like a mirror. Consequently, a significant portion of the incident energy may be reflected. The loss in coupling efficiency of the first order waves relative to the zeroth order (normal incidence) may result in a loss of image contrast, and hence, resolution.

### BRIEF DESCRIPTION OF THE DRAWINGS

FIG. 1 is a sectional view of a wafer including a photoresist with a first order transmission optimizing (FOTO) top coat.

FIG. 2 is a side view of a projection lens having an numerical aperture (NA).

FIG. 3 is a side view of zeroth order and first order diffracted waves from an ultra high NA projection lens.

FIG. 4 is a graph showing coupling efficiencies of Transverse Electric (TE) and Transverse Magnetic (TM) polarization modes for a photoresist without a FOTO top coat.

FIG. 5 is a graph showing coupling efficiencies of TE and TM polarization modes for a photoresist with a FOTO top coat.

FIG. 6 is a sectional view of a wafer including a photoresist with a FOTO top coat and a bottom anti-reflective coating (BARC).

### DETAILED DESCRIPTION

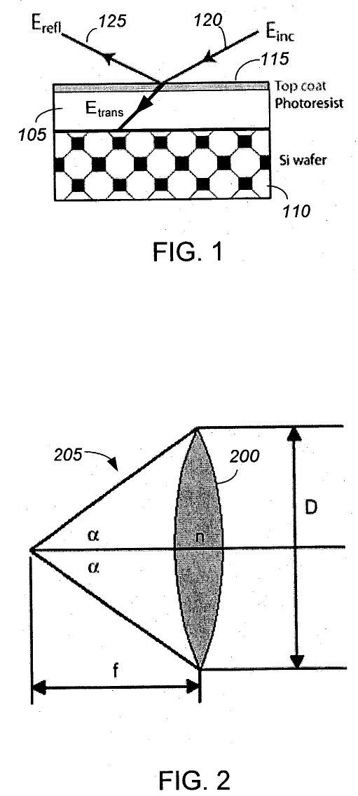

During a lithography imaging operation, light directed onto a patterned mask (or “reticle”) may be projected onto a layer of a photosensitive resist material (or “photoresist”) 105 on the top surface of a wafer 110, as shown in FIG. 1. A low absorption, low refractive index top coat 115 may be deposited on the photoresist layer to improve coupling of incident light 120 from a lens into the photoresist layer 105. The photoresist 105 and the top coat 115 may be developed and then etched to remove material from the areas exposed with the mask image.

A lithography imaging system may include a high numerical aperture (NA) lens. The NA of a lens may be given by n*sin α, where n is the refractive index of the ambient air between the resist and the last optical element and a is the half-angle of the largest cone of light entering the lens, as shown in FIG. 2. For example, a lithography imaging system with a resolution of 193 nm may have a lens with NA=0.8. Lithographic imaging systems requiring even higher resolutions may utilize ultra high numerical aperture (UHNA) (NA≧0.85) optics.

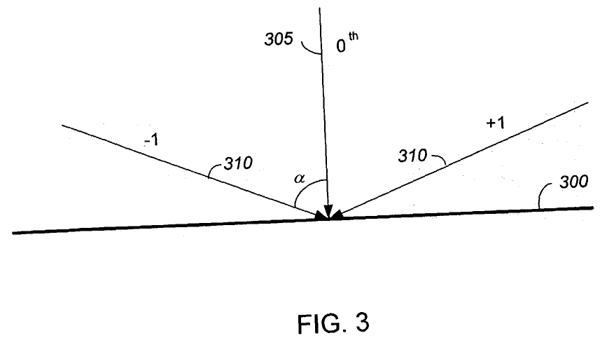

At very large numerical apertures, coupling light efficiently into the photoresist may become increasingly difficult, especially for nested features near the resolution limit of the lens. In a high NA imaging system, light waves reaching the wafer surface may be carried through zeroth (0) and first (±1) diffracted orders. The zeroth order waves 305 may be represented as an ensemble of plane waves hitting a photoresist surface 300 at near normal incidence, as shown in FIG. 3. The first (±1) diffracted order waves 310 may be represented as plane waves hitting the photoresist surface at opposite incident angles (θ) to the resist surface. The incident light from the zeroth and first order diffracted waves generated by the lens from a nested feature on the reticle may cause a three wave interference effect, which may create an image of the feature on the photoresist surface.

The incident angle, θ, of the first order waves may decrease as the NA of the imaging system increases. As θ decreases, the photoresist surface 150 may begin to act as a mirror. Consequently, the photoresist surface may reflect a significant portion 125 of the incident energy 120 (see FIG. 1). For example, for an NA=0.93 projection lens, the incident angle of the first order waves may be about 68°. In a lithography imaging system with a resolution of 193 nm and a photoresist with a refractive index n=1.78, only about 63% of the incident energy in the Transverse Electric (TE) polarization mode may be coupled into the photoresist layer, as opposed to 91% for the zeroth order mode. The loss in coupling efficiency of the first order diffracted waves relative to the zeroth order waves may result in a loss of image contrast and resolution capability.

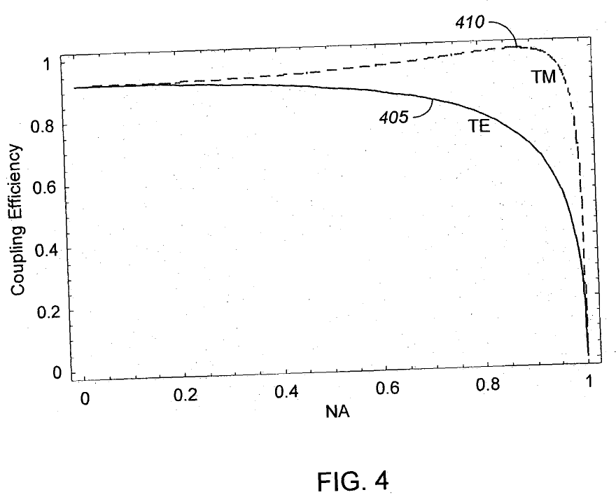

Another effect which may be associated with very high and ultra high NA imaging systems may be depolarization of the first order waves at the wafer plane. As shown in FIG. 4, the depolarization may cause a splitting of the incident TE field into TE 405 and Transverse Magnetic (TM) 410 polarization modes which may exhibit significantly different resist coupling efficiencies. The asymmetry between the coupling of the TE and TM mode energy may deteriorate imaging performance by causing the rotational asymmetry in the image. Furthermore, splitting of the TE and TM modes may produce artifacts, e.g., different images in the two modes, which may blur the image projected onto the photoresist surface.

The addition of a relatively low absorption, low refractive index top coat 115 layer, with respect to the photoresist, in very high and ultra high NA imaging systems may considerably improve the low TE coupling efficiency and TE-TM splitting at large incident angles.

The thickness of the top coat 115 may be selected to substantially cancel the reflected portion 125 of the incident energy 120, which may enhance energy transfer to the photoresist layer 105. The thickness (t) of a top coat with a refractive index (n) at wavelength (λ) may be optimized for a given lens with numerical aperture (NA) using the following approximate equation:

$$t = \frac{λ}{4 n \sqrt{1 - {( \frac{NA}{n} )}^{2}}}$$

Optical design software may be used to further fine tune the result for better optimization. Suitable software packages may include, e.g., OSLO by Sinclair Optics, Inc. of Fairport, N.Y. and Zemax® by Focus Software, Inc. of Tucson, Ariz.

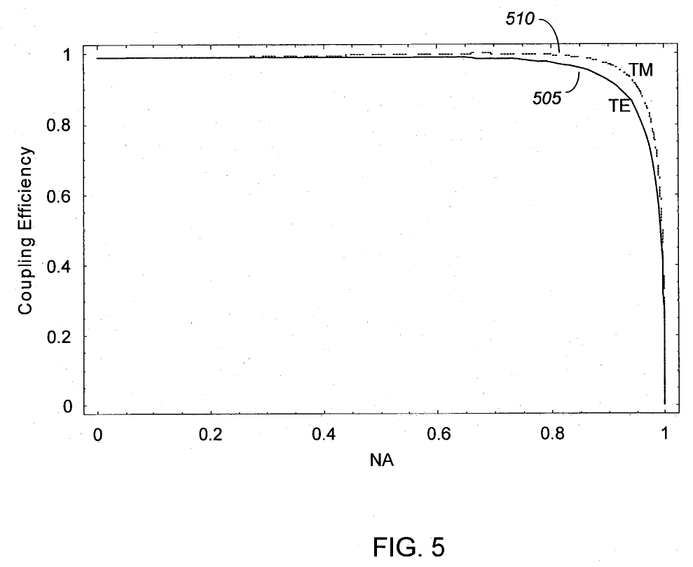

The effects of the top coat may be shown in the following example. A 420 Å thick top coat 115 with a refractive index n=1.4 may be deposited on a photoresist 105 with a resolution of 193 nm and a refractive index n=1.78. FIG. 5 shows computed energy coupling efficiencies for the TE and TM modes for different plane wave incident angles. The TE/TM response curves 505, 510 indicate that the TE/TM splitting has been considerably improved. The TE and TM mode efficiencies closely match each other over a large incident angle range covering normal (NA=0) incidence to grazing incidence (NA=1). Incident angles over the range have a similar coupling efficiency and hence image contrast may be maintained close to ideal. The coupling efficiency for the TE mode at NA=0.93, e.g., about 91%, may closely match that of the TM mode. This result is a considerable improvement over the coupling efficiency of 63% for the case with no top coat.

An exemplary top coat material is AZ® Aquatar®, an aqueous-based top antireflective coating produced by AZ the Clariant Corporation of Somerville, N.J. The material can be spin coated and is compatible with most commercially available photoresists. The material has a refractive index of about 1.45 at 193 nm.

A bottom anti-reflective coating (BARC) may be deposited on a wafer surface to control the effects of thickness variations in the photoresist layer. The BARC may include an absorptive material which reduces reflectivity at the wafer surface 610. The BARC may reduce “swing curve,” a thin film interference effect which may be caused by reflections within the photoresist layer. Swing curve may be affected by the thickness of the resist, since reflections may be amplified or attenuated depending on the local resist thickness.

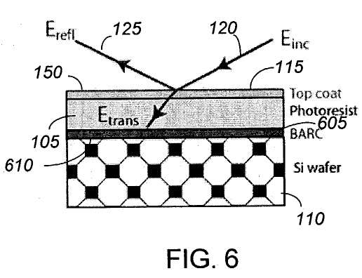

Typically, either a BARC or a top coat may be used to control the effects of thickness variation. In an embodiment, a BARC 605 may be deposited on a wafer surface 610 in addition to the top coat 115 on the photoresist 105, as shown in FIG. 6. By using both a top coat and a BARC, the effects of thickness variation may be controlled while increasing coupling energy to the photoresist.

A number of embodiments have been described. Nevertheless, it will be understood that various modifications may be made without departing from the spirit and scope of the invention. Accordingly, other embodiments are within the scope of the following claims.

1. An article comprising:
a wafer having a surface;
a layer of photoresist material over the wafer surface;
a top coat on the photoresist layer operative to substantially cancel a reflected portion of radiation having a wavelength λ.

2. The article of claim 1, wherein the top coat has a thickness approximately equal to
$$\frac{λ}{4 n \sqrt{1 - {( \frac{NA}{n} )}^{2}}} ,$$
where n is
the refractive index of the top coat and NA is a numerical aperture of an optical system.

3. The article of claim 2, wherein the NA is greater than about 0.7.

4. The article of claim 1, wherein the top coat comprises a substantially low absorption, low refractive index material.

5. The article of claim 4, wherein the top coat comprises a material having a refractive index of about 1.5 or less.

6. The article of claim 4, wherein the top coat has a thickness of about 500 Å or less.

7. The article of claim 1, wherein the top coat is operative to couple radiation into the photoresist material such that the magnitude of the Transverse Electric (TE) polarization mode of the radiation is substantially equal to the Transverse Magnetic (TM) polarization mode of the radiation over the range of NA from 0 to 1.

8. The article of claim 1, wherein the top coat is operative to couple radiation into the photoresist material such that the magnitude of the Transverse Electric (TE) polarization mode of the radiation is substantially equal to the Transverse Magnetic (TM) polarization mode of the radiation at an NA of about 0.80 and higher.

9. The article of claim 1, wherein the top coat is operative to couple greater than about 75% of a Transverse Electric (TE) polarization mode of an incident radiation at an NA of about 0.93.

10. The article of claim 1, wherein the top coat is operative to couple greater than about 90% of a Transverse Electric (TE) polarization mode of an incident radiation at an NA of about 0.93.

11. An article comprising:
a wafer having a surface;
a layer of photoresist material over the wafer surface;
a bottom anti-reflective coating (BARC) between the wafer and the layer of photoresist material; and
a top coat on the photoresist layer operative to substantially cancel a reflected portion of radiation having a wavelength λ.

12. The article of claim 11, wherein the top coat has a thickness approximately equal to
$$\frac{λ}{4 n \sqrt{1 - {( \frac{NA}{n} )}^{2}}} ,$$
wherein n
is a refractive index of the top coat and NA is a numerical aperture of an optical system.

13. The article of claim 12, wherein the NA is greater than about 0.7.

14. The article of claim 11, wherein the top coat comprises a substantially low absorption, low refractive index material.

15. The article of claim 14, wherein the top coat comprises a material having a refractive index of about 1.5 or less.

16. The article of claim 15, wherein the top coat has a thickness of about 500 Å or less.

17. The article of claim 11, wherein the top coat is operative to couple radiation into the photoresist material such that the magnitude of the Transverse Electric (TE) polarization mode of the radiation is substantially equal to the Transverse Magnetic (TM) polarization mode of the radiation over the range of NA from 0 to 1.

18. The article of claim 11, wherein the top coat is operative to couple radiation into the photoresist material such that the magnitude of the Transverse Electric (TE) polarization mode of the radiation is substantially equal to the Transverse Magnetic (TM) polarization mode of the radiation at an NA of about 0.8 and higher.

19. The article of claim 11, wherein the top coat is operative to couple greater than about 65% of a Transverse Electric (TE) polarization mode of an incident radiation at an NA of about 0.93.

20. The article of claim 11, wherein the top coat is operative to couple greater than about 90% of a Transverse Electric (TE) polarization mode of an incident radiation at an NA of about 0.93.

21. A method comprising:
depositing a top coat on a layer of photoresist material over a substrate;
exposing the top coat to light in a lithography system having a numerical aperture (NA) of about 0.8 or higher, said light including a Transverse Electric (TE) polarization mode energy; and
coupling greater than about 80% of the TE polarization mode energy into the photoresist material.

22. The method of claim 21, further comprising:
depositing a bottom anti-reflective coating (BARC) on the substrate; and
depositing the layer of photoresist material on the BARC.

23. The method of claim 21, wherein said exposing comprises exposing the top coat to light in a lithography system having a numerical aperture (NA) of about 0.9 or higher.

24. The method of claim 21, wherein said depositing comprises depositing the top coat at a thickness approximately equal to
$$\frac{λ}{4 n \sqrt{1 - {( \frac{NA}{n} )}^{2}}} .$$

25. The method of claim 24, wherein the thickness is deposited to a thickness of about 500 Å or less.

26. The method of claim 21, wherein said depositing comprises depositing a substantially low absorption, low refractive index material.

27. The method of claim 26, wherein the material has a refractive index of about 1.5 or less.
